(19) United States
(12) Patent Application Publication
(10) Pub. No.: US 2007/0293208 A1
(43) Pub. Date: Dec. 20, 2007

(54) Wireles switching control system for building automation, lighting, security and appliances

(75) Inventors: Kuam Hong Loh, Georgetown (MY); Hong Keng Lim, Sungai Dua (MY)

Correspondence Address: MERCHANT & GOULD PC, P.O. BOX 2903, MINNEAPOLIS, MN, 55402-0903, US

(73) Assignee: Newict (M) Sdn. Bhd., Bayan Bay (MY)

(21) Appl. No.: 11/818,694

(22) Filed: Jun. 15, 2007

(30) Foreign Application Priority Data
Jun. 15, 2006 (MY) PI 20062826

(51) Int. Cl. H04M 3/00

(52) U.S. Cl. 455/419

(57) ABSTRACT

The present disclosure discloses an expandable wireless control system for and a method of managing and controlling building automation, lighting system, security system and electrical appliances. This system, based on a concept of modular mailboxes intercommunicating wirelessly by radio frequency and infrared frequency, can be used in new homes and buildings or easily retrofitted into existing homes and buildings without any need for massive rewiring, comprises of: microprocessor control switch panel, handheld remote devices, user input interface device, wireless multipurpose transceiver unit (MPU, 300) that interpose with remotely controllable subsystem of third party devices and electrical appliances to enable control of these devices to become a part of said system, and a wireless multipurpose transceiver with communication interface (MPUCOM, 302) in combination with a graphical user interface software that turns a personal computer into a setup computer, command centre, remote management gateway that connects to internet and telecommunication network (702).

### BACKGROUND

1. Field of Invention

This present disclosure relates to an expandable wireless control system for and a method of managing and controlling building automation, lighting system, security system and electrical appliances. This system, based on a concept of modular mailboxes intercommunicating wirelessly by radio frequency and infrared frequency, can be used in new homes and buildings or easily retrofitted into existing homes and buildings without any need for massive rewiring.

2. Prior Art

There are many known automation systems described in prior art that remotely control lighting and electrical appliances using handheld remote in tandem with centralized control panel either, wired, wireless or via power line carrier communication system. Many of the prior arts are centralized system—focused to be more expandable with increase mobility, more compatible and also to provide more competent control of increasingly sophisticated functions or even anticipated future functions provided by modern appliances. In pursuing these ideals, many of the prior art itself became complex and expensive with lots of build in redundancy.

Besides needing a central control unit, U.S. Pat. No. 6,567,032 to Mullaly et al., U.S. Pat. No. 5,815,086 to Ivie et al. and U.S. Pat. No. 6,297,746 to Nakazawa et al. require customized receiver control unit to be built-in and retrofitted into every electrical appliances that users wanted to control. This is neither practical nor economically feasible.

In the teachings of U.S. Pat. No. 5,838,226 to Houggy et al. on a centralized automated lighting control system via radio frequency(RF) two-way communication protocol with plurality of repeaters, RF signals are received by every lighting switches in the group, thus, each lighting switch must have a unique identification number (ID). Similarly, for power line communication system. With so many IDs, a fairly complex handheld control unit is required to control these lightings.

In the teachings of U.S. Pat. No. 5,227,780 to Tigwell et al. where a plurality of transponders stores received infrared signals, and later matched it to a received UHF signal prior to transmitting a matching infrared signals. It would be more practical to send the data of said infrared signals in UHF to a particular transponder with the frequency of said infrared information attached as part of a data packet. The receiving transponder then recreate said infrared signal and transmit it back out. Thus, any transponder can be used to broadcast said infrared signal rather than a specific transponder that has said infrared matching information.

In the teachings of U.S. Pat. No. 5,909,183 to Borgstahl et al., the method of peer-to-peer is quite convoluted. Every peer can be simplified to a mailbox with an address and a group security identification code that allows it to read (decrypt) in-coming mail or transmit (encrypt) out-going mail to other mailboxes. And with a small set of instructions embedded into said mailbox, just like micro-codes in microprocessors, the ability of said mailboxes will become flexible and limitless.

In the teachings of U.S. Pat. No. 5,086,385 to Launey et al. (1992), all the different interfaces are no longer relevant as there are now available common interfaces like Wi-Fi 802.11, Bluetooth, USB and Firewire and the likes.

One of the disadvantages in all prior art attempts to automate a building, that has never been satisfactorily resolved, is easy installation and retrofitting without any need for massive rewiring.

### SUMMARY

The inadequacies of inventions disclosed by prior art are evident. Accordingly, one object of certain illustrative embodiment of embodiments disclosed herein is to overcome the drawbacks mentioned above. The primary object of one embodiment is the control of “chi” for building automation. Electrical switches. This is where electrical power is directly available and distributed to all lighting and electrical apparatuses throughout the whole building. These ‘chi’ controlling devices (electrical switches) are accessible and visible everywhere in the building. Therefore, pertinent information displayed on these switch panels from various applications can be easily seen. With proper input interface embedded into these switch panels, users will also have access and control of these various applications at almost anywhere in the building. Besides ‘chi’ control, electrical switch panels are points of convergence.

More specifically, the present disclosure is based on the concept of modular mailboxes intercommunicating wirelessly. In at least some embodiments, every component of the embodiment behaves as wireless mailboxes. These components are: microprocessor control switch panels, handheld remote control devices, multipurpose transceiver unit (hereinafter refer to as MPU) to interpose with electrical appliances and remotely controllable subsystem wherein comprises of third party devices (i.e. security system, sensors, audio-visual system, air conditioners, personal computers and the likes) to enable arbitrary adoption of these third party devices to become a part of the embodiment, a graphical user interface software in combination with a MPU with communication interface (hereinafter refer to as MPUCOM) connected to a personal computer communication port, preferably a USB port.

A further object of certain illustrative embodiment of embodiments disclosed herein is that all mailboxes of the same group uses a common multi-digit alphanumeric radio frequency identification (hereinafter refer to as RFID), channel number for radio frequency intercommunication and infrared remote identification number (hereinafter refer to as RID). In order to be modular and independent, every mailbox has a copy of this information. No registration is necessary with any centralized devices. Centralized control panel is optional.

A further object of certain illustrative embodiment of embodiments disclosed herein is to provide multi-digit alphanumeric remote identification (hereinafter refer to as RID) on handheld infrared transmitter, as part of infrared transmission format to prevent unauthorized access and cross control from adjacent infrared transmitters, especially in high density areas like offices and apartments. RID of different length of RID can be used depending on the security needs. The same RID must also input into all components of the group that listen to infrared frequency like microprocessor control switch panels and MPU in order for it to recognize and accept IR transmission from all infrared transmitters with the same RID.

A further object of certain illustrative embodiment of embodiments disclosed herein is to provide a secure yet simple to perform method to setup and initialize a system of modular wireless mailboxes. I presently contemplate that the ‘Ping’ method describe below is sufficient, secure and simple to setup a system of modular wireless mailboxes. However, other forms of ‘Ping’ are also possible using different formats and protocols.

At initial setup of the invention, all mailboxes are installed into locations with electrical wiring connected and electrical power turned ON. Each mailbox has a factory default RFID that allows it to receive and to respond to said ‘Ping’ broadcast from a setup computer.

Said setup computer means a combination of a processor based computing device, like a laptop computer, loaded with said graphical user interface software with said MPUCOM connected to its communication port ready to interpose with said mailboxes of said system ‘Ping’ is a radio frequency transmission that requests all components of the system with factory default RFID to identify itself by sounding its buzzer and flashing its light emitting diodes (hereinafter refer to as LED) lights.

A person with the setup computer, preferably a handheld computer, will broadcast the ‘Ping’ and walk around, room by room and physically press any switch, once, on each component that responded. Thus, prompting each of these components to transmit its unique serial number by radio frequency to the setup computer. Components that do not have switches, like MPU, or located in a position that is difficult to reach or access can be prompted to transmit its unique serial number to the setup computer by using a handheld infrared remote. The reason for physical prompting or using infrared prompting is security—that is to prove that whoever broadcasted the ‘Ping’ is the legitimate owner or authorized personnel to setup the system by meeting the following 4 requirements. One, knowing the location where the system is being setup. Two, knowing that the system is in its factory default state. Three, knowing that the system is fully connected with power turned on and the finally, the most important of all, having complete access to the location where the system is being setup, to prompt the system. Besides these 4 requirements mentioned above, other combinations of security measures are also possible, either more stringent or more relax, depending on the applications and level of security requirements.

Upon completion of the ‘Ping’ procedure, the setup computer will encrypt and transmit RFID, channel number, RID and other relevant information in accordance to each serial number. Upon receipt of this transmission, component of this serial number will update its factory default RFID, channel number and RID to the newly received RFID, channel number and RID, thus becoming a mailbox that is now a legitimate member of the group. The system is now secured and will only respond to any broadcast with the correct channel number, RFID and RID.

Upon complete setup of the system according to one aspect of the disclosure as a system of modular wireless mailboxes, a further object of certain illustrative embodiment of embodiments disclosed herein is that any mailbox can send or forward mails or commands to other mailboxes. All mailboxes are independent of other mailboxes. Dependencies can be included if require. Mailboxes can be included or excluded from the system dynamically.

Like the mail system in our real world, the postman does not really care what is written in your letters but only needed the addresses of mailboxes to deliver the mail. In a reciprocal manner, the recipients of the letters do not really care how these letters arrived in their mailboxes, but rather the authenticity of the senders and content of their mail to decide and work out what to do next. Therefore, it is another object of certain illustrative embodiment of embodiments disclosed herein that property settings of these mailboxes can be adjusted and customized according to one's needs and environment.

A further object of certain illustrative embodiment of embodiments disclosed herein is that any mailbox can be selected as clock source to broadcast real time clock information, for clock synchronization, to other mailboxes upon request or upon return of power after power failure. Any mailbox that is selected as clock source can also synchronize its clock with a PC if there is a PC available.

A further object of certain illustrative embodiment of embodiments disclosed herein is to provide communicating control by proxy. A mailbox is allowed to request another mailbox to control or communicate with other mailboxes on its behalf. The autonomy to make decision given to the proxy mailbox to act on behalf is based on certain guidelines and/or occurrence of certain conditions. An example is a PC that has updated its real time clock on the Internet, and instead of broadcasting this clock information to every mailboxes, the PC broadcast it to the proxy mailbox. The proxy mailbox will then confirm the clock information from the PC to its own clock according to a set of guidelines prior to deciding whether to re-synchronize all the clocks of other mailboxes.

A further object of certain illustrative embodiment of embodiments disclosed herein is to provide for audio type applications like paging, baby monitor, for retrieving voice messages or voice memo reminder from any mailboxes.

A further object of certain illustrative embodiment of embodiments disclosed herein is to enable retrieval and sending of e-mail from PC to mailboxes with LCD screen and vice versa.

A further object of certain illustrative embodiment of embodiments disclosed herein is to provide a visual communication interface like a touch screen or an LCD with keypad inputs that accepts command inputs by a user for instructing the systems to perform its control operations.

A further object of certain illustrative embodiment of embodiments disclosed herein is to provide visual and audio indications on mailboxes during arming, disarming and other status of security system.

A further object of certain illustrative embodiment of embodiments disclosed herein is to provide visual and audio indications on mailboxes when security system is trigger. User has the flexibility to sound the alarm either discreetly on mailboxes at selected locations, or globally, as at all the mailboxes in the whole building.

A further object of certain illustrative embodiment of embodiments disclosed herein is to provide a method to selectively lock and unlock input interfaces of mailboxes, either responding to or not responding to wireless type inputs and direct input interface on said mailboxes. Microprocessor control switch is an example where these capabilities can be utilized whereby preventing unauthorized access of said microprocessor control switch panel that are in use in public places.

A further object of certain illustrative embodiment of embodiments disclosed herein is creation of virtual remote on PC, by digitizing infrared signals from any infrared transmitter and assign to buttons on the virtual remote. This digitized infrared information is transmitted in RF by the virtual remote, from PC to target location and reconverted by an MPU to its original infrared signal to control any intended electrical appliances as if it were the transmission from the manufacturer infrared remotes.

A further object of certain illustrative embodiment of embodiments disclosed herein is to provide a synchronized multi way switching control via radio frequency. For example, a switch in room A, via radio frequency, can be configured to control the light that is control by the switch at the staircase. An action that turns OFF the switch in room A will turned OFF the light control by the switch at the staircase. A synchronized OFF status is reflected accordingly on both switches. Any action taken at the switch at the staircase will also be similarly reflected at switch A.

Imagine the simplicity. You have the simplicity and the flexibility to clone any switch in the building and place it at the location of your choice.

Unlike mechanical switches that can be operated manually, electronically control switches require power to change state. Thus, another object of certain illustrative embodiment of embodiments disclosed herein is to provide battery power to enable user to selectively turn ON, turn OFF or changes the power output level for switches on microprocessor control switch panel during power failure. By pressing the battery power button, that is available on every microprocessor control switch panel, battery inside the microprocessor control switch panel will provide electrical power to all the internal circuits. Switches in the ON position will be lighted. Switches in the OFF position will not be lighted. While pressing the battery power button, user can change the power output level or the state of these switches to either ON or OFF position.

A further object of certain illustrative embodiment of embodiments disclosed herein is to provide visual indicator on microprocessor control switch panel for easy identification when switches are in ON position or in OFF position.

A further object of certain illustrative embodiment of embodiments disclosed herein is to provide visual indicator of different color on microprocessor control switch panel when switches are control by background timers or events like calendars and macros.

A further object of certain illustrative embodiment of embodiments disclosed herein is to provide handheld transmitters either via wireless like infrared (hereinafter refer to as IR) or radio frequency (hereinafter refer to as RF) for control operations that are used daily, like turning ON or turning OFF lights, arm or disarm alarm system, opening of automatic garage door and the likes.

Other and further objects, features and advantages of the embodiment disclosed herein will become apparent with the detailed description of the drawings and the presently preferred embodiment of the invention.

### BRIEF DESCRIPTION OF THE DRAWINGS

Even though not exhaustive, the following are illustrations to assist in the easier understanding and appreciation of the many advantages and objects of the present invention.

FIG. 1A to FIG. 1D is a detail three dimensional drawing of one embodiment of microprocessor control switch panel 100. While FIG. 1E to FIG. 1I show other embodiment of microprocessor control switch panels 100.

FIG. 2 shows one embodiment of an input keypad.

FIG. 3 shows one embodiment of multi-purpose transceiver unit 300 and its features for automation application, hereinafter refer to as MPU unit.

FIG. 4 shows one embodiment of a handheld infrared transmitter 400 for line of sight application, hereinafter refer to as IR Transmitter.

FIG. 5 shows one embodiment of a handheld radio frequency transmitter 500, hereinafter refer to as RF Transmitter.

FIG. 6 shows one embodiment of a flow chart of the concept of modular wireless mailboxes.

FIG. 7 shows one embodiment of the present invention as a cohesive system of modular wireless mailboxes.

FIG. 8 shows one embodiment of an exemplary relationship between external devices and components of the system according to one aspect of the disclosure in a typical application.

FIG. 9 shows one embodiment of the present invention communicating control by proxy.

FIG. 10 shows one possible embodiment of the present invention in an advance application environment.

### DESCRIPTION OF THE PREFERRED EMBODIMENT

With references to the drawings that form a part hereof, in which the preferred embodiment of the present invention may be practiced, it is understood that other embodiments may be utilized as structural changes may be made without departing from the scope of the present invention.

Referring to the drawings, all this will become clear as the preferred combinations of embodiments are explain in detail.

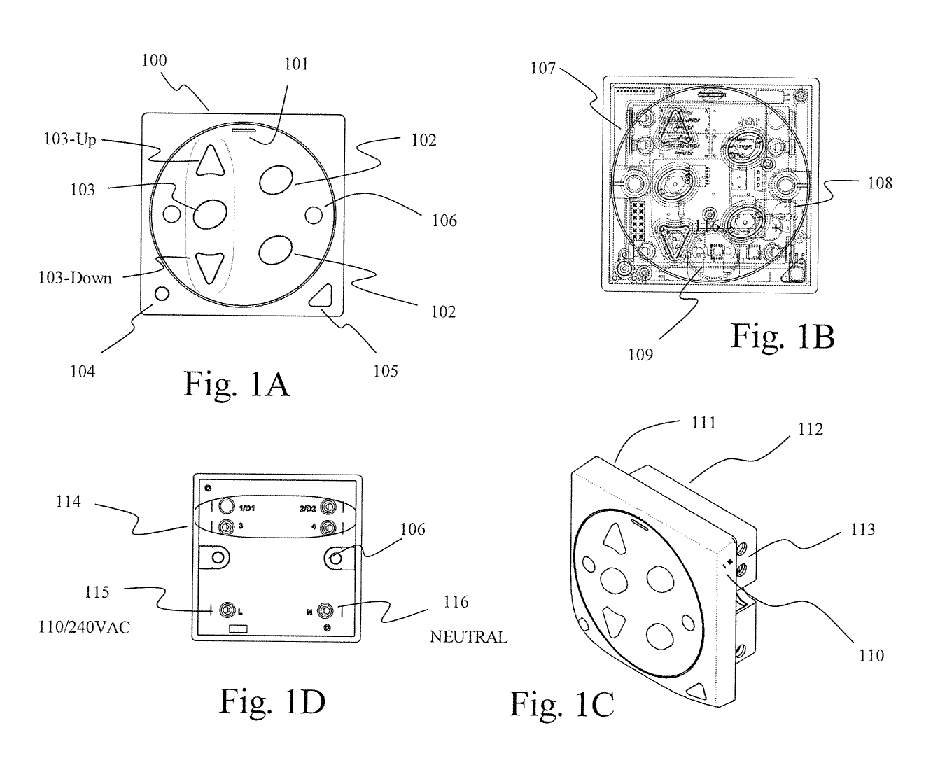

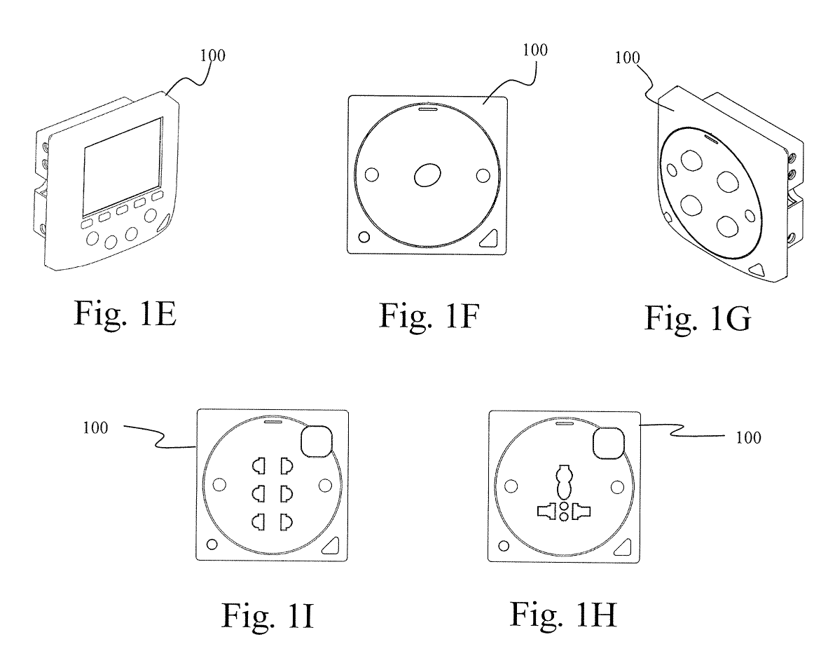

FIG. 1A is the front view of one embodiment of a microprocessor control switch panel 100. 101 is a light emitting diode (LED) visual indicator for line power and also as security alarm indicator. Below is a table for the different mode of 101 LED

| Blue Light | Red Light | Remarks |
|---|---|---|
| OFF | OFF | Power failure or power to microprocessor control switch panel |
| | | 100 is turned OFF. |
| ON | OFF | Line power is available to all electronics and |
| | | security system is not active |
| OFF | ON | Without buzzer sound, security system is arm and ready |
| | | With buzzer sound, user is given a time delay to exit during |
| | | arming of security system. Upon expiry of time delay to exit, |
| | | security system is arm and ready with buzzer turn OFF. |
| | | With buzzer sound, user is given a time delay to unarm the |
| | | security system when accesses the premise. Input of correct |
| | | password before expiry of entry delay time, security system is |
| | | disarm. Else security system triggers upon expiry of entry delay |
| | | time. |
| | | Both scenarios at designated entrance only. |
| Blinking | Blinking | Security system has triggered and accompanied by siren sound. |

102 and 103 is an ON-OFF toggle switch for lighting or appliances that is connected to it. Below is the status table of 102 and 103:

| Blue backlight | Red backlight | Remarks |
|---|---|---|
| OFF | OFF | Switch in OFF state. No background event is running |
| OFF | ON | Switch in OFF state, but background events like timers, |
| | | macros or calendar is active |
| ON | OFF | Switch in ON state. Any lighting or appliance connected |
| | | to it is receiving power. No active background event. |
| ON | ON | Switch is in ON state. Any lighting or appliance |
| | | connected to it is receiving power. Background events like |
| | | timers, macros or calendar is active |
| Don't care | Blinking | Together with buzzer sound, system ‘ping’ each other for |
| | | information retrieval and also during setup |

Switch 102 is programmable to toggle mode or to momentary mode. Toggle mode is meant for ON-OFF application like lighting and providing power to electrical appliances. Whereas momentary mode is meant for open-close applications like garage door, auto-gate or application that requires a predetermined duration of short pulses for activation.

The output power level control comprises of a group of three switches, that is 2 triangular up-down selection buttons 103-up 103-down with an ON-OFF switch 103 in the middle. Various types of applications like light intensity control, fan speed, roller blinds up-down control uses the output power level control buttons. The ON-OFF switch 103 behaves exactly as the ON-OFF switch in 102. The 103-Up button is meant to increase output power level, light intensity, increase speed or scrolling upwards. A continuous beep will sound to indicate that output is at its maximum power or maximum speed or maximum level. The 103-Down button is meant to do the opposite of 103-Up button. A continuous beep will sound and the blue backlight of the ON-OFF switch 103 in the middle will turn OFF to indicate that output is shut off or speed or level is at zero level.

Unlike mechanical switch that can be turned ON or turned OFF manually, electronically control switches cannot operate without power. It is impossible for user to select a desired state, either ON or OFF, for a particular appliance connected to an electronically control switch like 102 or 103 during power failure. Switches on microprocessor control switch panel 100 needs electrical power to operate. Furthermore during power failure, one can examine the position of physical switches to determine whether it is in an ON state or in an OFF state, and therefore can decide accordingly either to leave the switch in ON state or to tuna it OFF. On the other hand, electronically control switches are usually toggle switches. Each time an electronically control switch is press and release, a microcontroller will record its last state, either from ON state to OFF state or vice versa, into non-volatile memory. During power failure user is not able to differentiate whether an electronically control switch is in ON state or in OFF state prior to the power failure. Any indication like display panel or illumination on the switch itself to indicate its last state is no longer available. It is not unusual for normal lay person to make assumptions that no display, no indicator meant all connected equipment will be in an OFF state when power is restored! The uncertainty in tandem with the inability to easily and safely select a safe state for any equipment or appliances connected to electronic switches during power failure can be a potential danger or cause of great pecuniary losses when electrical power is restore after a power failure. For example, a heater could be unintentionally left in ON state or an important piece of ventilation equipment in OFF state that must be turned ON when power is restore. An important feature for electronically control switch is to enable user to select the desire state for their equipment, (i.e. ON, OFF or at a certain power level) during power failure The purpose of battery power button 104 is to overcome the problem mentioned above. The power comes from a coin type battery 109 as shown in FIG. 1B. 104 is a momentary switch. User must press and hold down battery power button 104 to provide temporary power to the electronics on the microprocessor control switch panel 100 during power failure. No power is provided to loads connected to these switches. While pressing down battery power button 104, user can see which button on the panel is in ON state and which button on the panel is in OFF state. Switches in ON state will be lighted and switches in OFF state will not have any back lighting. User can manually press any switch of their choice to toggle from ON to OFF and vice versa, or adjust the output power level to the level of their choice for their equipment when power returns.

105 is infrared (IR) transceiver window. All incoming and outgoing IR communication is through this window. Optionally, the window 105 can be used for camera if required.

106 are screw holes for flush mounting of microprocessor control switch panel 100 onto wall. FIG. 1A and 1D shows 106 from front and from back. Two caps are provided to close these screw holes for better aesthetic look.

All incoming and outgoing radio frequency communications is control by this board 107 embedded at the upper right hand corner of the microprocessor control switch panel 100. 108 is a buzzer behind the right section of the microprocessor control switch panel 100. This buzzer is an audio acknowledgment of action performed by user or alarm for security system. For example, turn ON or OFF a switch, arm security system, change fan speed or light intensity level. Optionally, the buzzer can be replaced with a mini speaker for audio type applications like paging, baby monitor, for retrieving voice messages or voice memo reminder.

109 is coin type battery that provides temporary power to the electronics on the microprocessor control switch panel 100 when battery power button 104 is pressed during power failure.

110 is an optional microphones for paging, baby monitor, voice memo or any types of application that requires audio pickup.

Wall flush mounting is up to line 111. 112 is the protective back casing which protects the electronics. 113 are side openings for screws to brass terminals to hold incoming and outgoing wires for proper electrical connections. Different type of microprocessor control switch panel 100 has different numbers of brass terminals. 115 is brass terminal for incoming live wire like 110/240 VAC and 116 is brass terminal for neutral wire. Power to onboard electronics is extracted from 115 and 116. The remaining power from 115 and 116 are electronically control and routed to a group of brass terminals 114 for outgoing wires that are connected to lighting and electrical appliances.

FIG. 1E to 1I shows a variety of possible of microprocessor control switch panel 100 for different applications. FIG. 1E is a panel with liquid crystal display (LCD) that is flexible and can be used for many different applications like audio/video communications and reading e-mails besides controlling lights. FIG. 1F is a single switch panel that can be used for higher current rating. FIG. 1G is a panel with 4 switches. FIG. 1H and FIG. 1I are panels for power outlets.

A common and important feature for all the of microprocessor control switch panel 100 shown here in FIG. 1 is that all inputs can be selectively disabled to prevent unauthorized access and accidental change of settings. This feature is especially useful for switch panels that are located in publicly accessible areas like corridors of shopping malls. There are 3 ways of accessing these microprocessor control switch panel 100: manually using the button(s) on the switch panel, via infrared using a handheld remote 400, via radio frequency using the handheld radio frequency remote 500 or via radio frequency with PC control as shown in computer 702. Below are the eight combinations:

Method to Access Control Of Microprocessor Control Switch Panel 100

| Manual/ | | | |
|---|---|---|---|
| Front Panel | | Via Radio | |
| Button(s) | Via Infrared | Frequency | Remarks |
| 0 | 0 | 0 | Nobody has access to |
| | | | control the microprocessor |
| | | | control switch panel except |
| | | | configuration control |
| | | | instructions transmit in |
| | | | radio frequency |
| 0 | 0 | 1 | Control via RF only |
| 0 | 1 | 0 | Control via IR only |
| 0 | 1 | 1 | Control via RF and IR |
| 1 | 0 | 0 | Manual control only from |
| | | | front panel. All remote |
| | | | access is disable. |
| 1 | 0 | 1 | Only IR control is disable |
| 1 | 1 | 0 | Only RF control is disable |
| 1 | 1 | 1 | Default. All access enable |

0 = Disable
1 = Enable

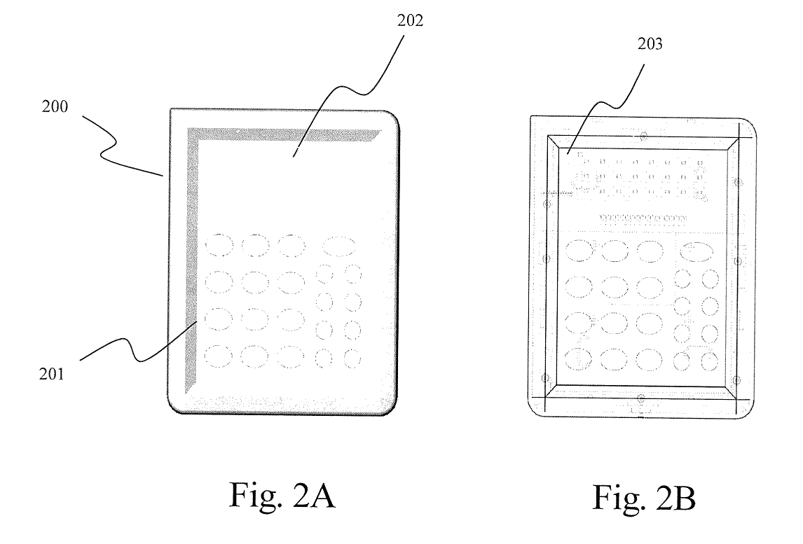

FIG. 2A and 2B show an embodiment of a wireless touch screen keypad 200. However, other forms of user input interface device are possible. The touch sensitive keypad is located at 201 while the space designated as 202 is for displaying commands and information received from and transmit to other mailboxes. 203 is a wireless radio frequency transceiver board—similar to 107.

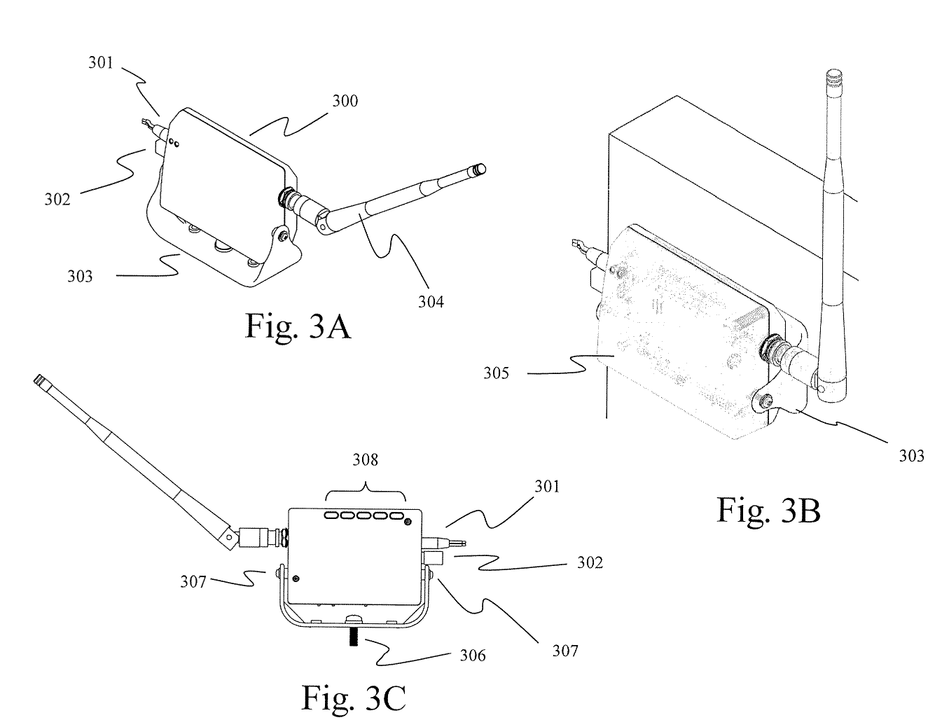

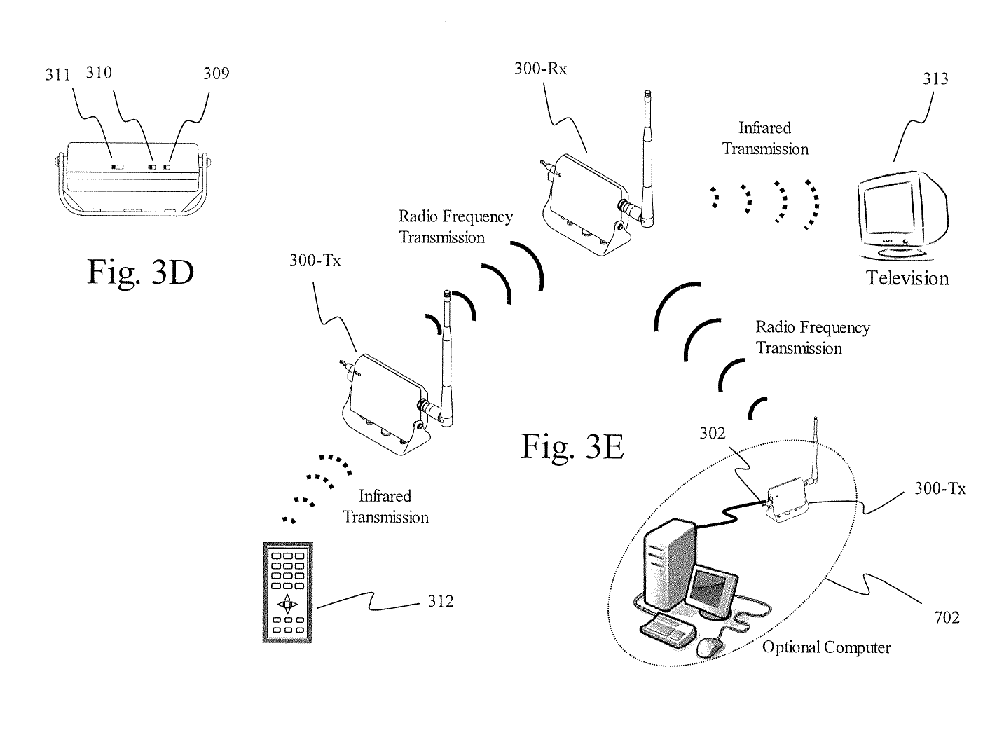

FIG. 3A to 3C shows three different mounting position of the multi purpose transceiver unit (MPU) 300. MPU with communication port interface 302 is known as MPUCOM and meant for interface to personal computer (PC). A possible port of communication with a PC is using the Universal Serial Bus (USB) port. Due to lower cost MPU or 300 without 302 is the preferred choice for interfacing with remotely controllable subsystem. 300 is an independent standalone device where power is provided using male DC input jack 301.

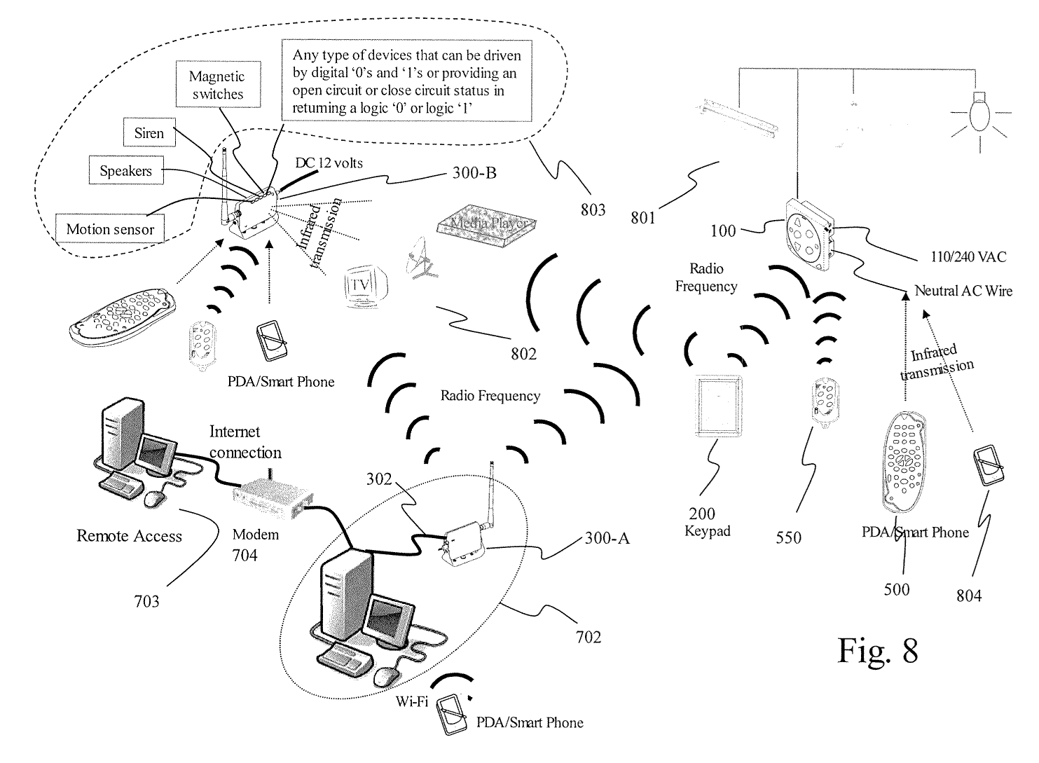

303 is a stand that can be adjusted for any mounting position for MPU 300. 304 is the external antenna for RF communications. 305 is transparent casing of the MPU which internally houses the infrared (IR) transceiver. 307 are two screws for position adjustment of one axis by approximately 210 degrees. Another axis of freedom is possible by adjusting the stand 303 and screw 306. There are 2 adjacent holes besides 306 for optional wall mounting adjustment. 308 are ports for direct control of subsystem which comprises of third party devices such as sensors, magnetic switches, relays, speakers and the likes. Subsystem remote from MPU 300 are control via infrared frequency as shown in 313 of FIG. 3E. The MPU subsystem control 300-B is illustrated in FIG. 8

With accompanying graphical user interface software, the IR receiver inside the MPU 300, connected to a PC via USB port, can be used to capture any infrared signal, digitized and assigned it to buttons on virtual remote created in the PC. This digitized infrared information is transmitted in RF to target location and reconverted by receiving MPU 300 to its original infrared signal to control any intended electrical appliances as if it were transmission from manufacturer's infrared remotes. MPU 300 can also be optionally configure to broadcast clock information to synchronize the system according to one aspect of the disclosure upon return of power after a power failure. Clock source mode for MPU 300 is important if there is no personnel computer within the system. A backup battery inside the MPU 300 will provide the necessary power to keep the clock running for several years during power failure or accidental shut off.

MPU 300 can also be configured to repeat infrared transmission non-native to the system according to one aspect of the disclosure. Receive and transmit of infrared can be separately control as shown in FIG. 3D. 309 is the selector to enable or disable infrared input. 310 is the selector to enable or disable infrared output. 311 is the channel number selector. There are three channels, namely 1, 2 and 3. During radio frequency transmission corresponding to non-native infrared repeater mode, MPU only communicates with other MPUs of the same channel.

If infrared input 309 is enable, this MPU will accept infrared transmission, non-native to the system according to one aspect of the disclosure, for example infrared transmission from TV handheld remote, and convert it into corresponding radio frequency for broadcast to other MPUs with repeater mode enable and of same channel number. 311 is the channel number selector. Receiving MPU will convert this radio frequency signal back to its original manufacturer infrared frequency and format, and transmit this infrared signal to control the intended electrical appliances. In this case a TV. If infrared output is enable 310 but infrared input 309 is disable, this MPU will only translate radio frequency corresponding to non-native infrared and transmit, but will not accept any infrared input for conversion to broadcast in radio frequency to other MPUs.

| Infrared | Infrared | |
|---|---|---|
| Input | Output | |
| (309) | (310) | REMARKS |
| Disable | Disable | Non-native IR repeat disable |
| Disable | Enable | Allow to convert radio frequency signal |
| | | corresponding to non-native infrared from other |
| | | MPU of same channel, convert to its original |
| | | infrared frequency, format and transmit. |
| | | Does not accept non-native infrared input for |
| | | conversion to broadcast in radio frequency to |
| | | other MPUs |
| Enable | Disable | Accept non-native infrared input for broadcast in |
| | | radio frequency to other MPUs |
| | | Does not allow conversion of radio frequency |
| | | signal corresponding to non-native infrared, |
| | | receive from other MPU of same channel, for |
| | | transmit |
| Enable | Enable | Allow to convert radio frequency signal receive |
| | | from other MPU of same channel, to its original |
| | | infrared frequency, format and transmit. |
| | | Accept non-native infrared input for broadcast in |
| | | radio frequency to other MPUs |

FIG. 3E shows a pictorial view of how MPUs interpose with electrical appliances and repeat infrared signal non-native to the system according to one aspect of the disclosure to control these appliances, in this case a TV, at a remote location. 312 is the TV remote control that is transmitting the non-native infrared control signal. Non-native signals can also come from virtual remote from PC as shown in FIG. 3E

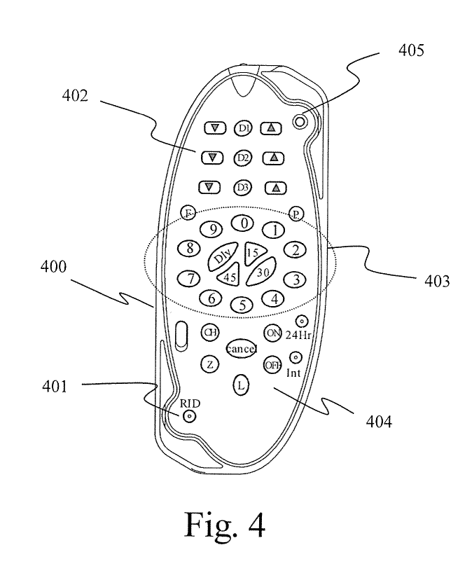

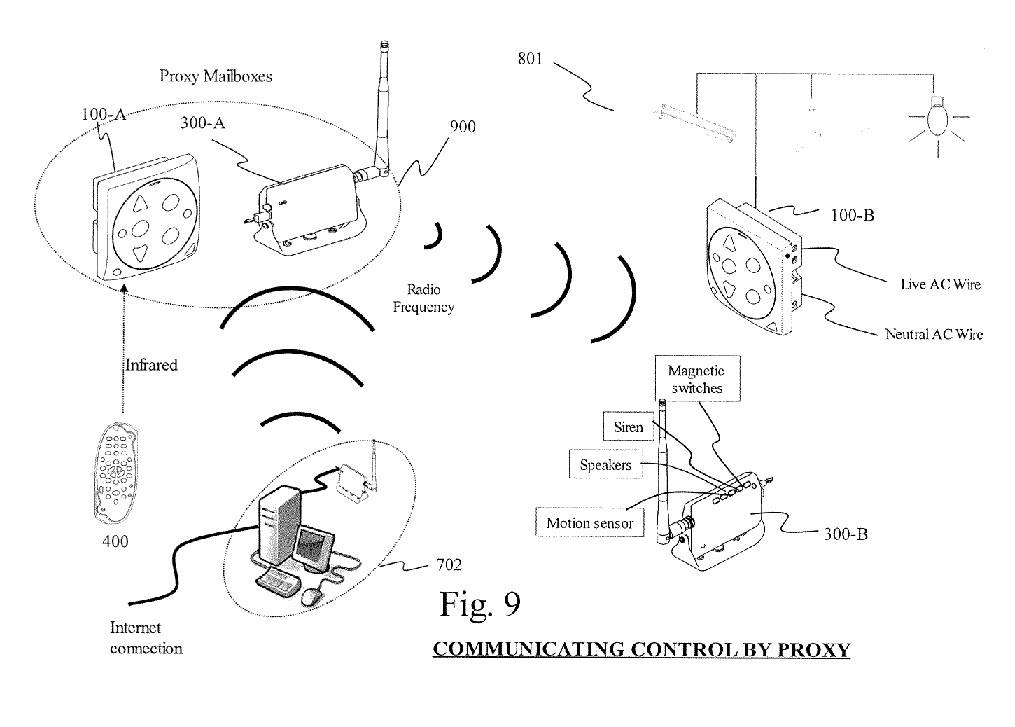

FIG. 4 one embodiment of the handheld infrared transmitter 400 for line of sight control. A unique remote identification number (RID) must be set before using the handheld infrared transmitter 400. This is to prevent unauthorized and accidental cross control from adjacent infrared transmitters, especially in high density areas like offices and apartments. User can input a multi-digit code keypad 403 while holding down RID button 401. The same RID number must also input into all mailboxes of the system according to one aspect of the disclosure that can receive infrared frequency like microprocessor control switch panels 100 and MPU units 300 in order for it to recognize and accept IR transmission from infrared transmitter unit 400. 402 are power level control buttons. 403 is for ON-OFF control while 404 is for advance control like zone, password and proxy control via microprocessor control switch panels 100 and MPU units 300. This proxy communication method will be illustrated in FIG. 9. 405 is a light emitting diode (LED) for visual indication of transmission in progress.

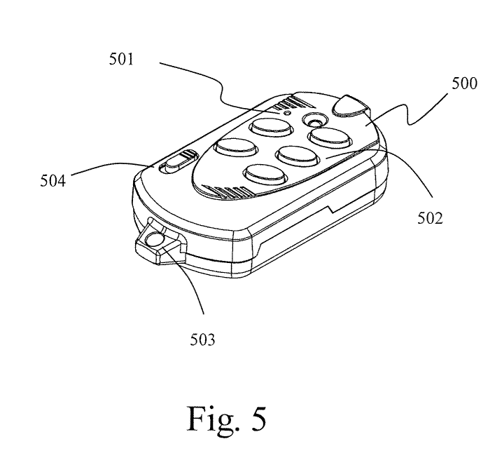

FIG. 5 shows one embodiment of mini radio frequency control unit (hereinafter referred to as miniRCU) 500 is for non line of sight application like arming and disarming of security system, turn ON turn OFF lighting in the house and access control. Before using the miniRCU 500, the first step is to program all the five buttons 502. Press button 501 to enter programming mode to start communication with MPU 300 connected via a USB port 302 to a personal computer which is installed with graphical user interface software of the system according to one aspect of the disclosure to program these five buttons 502. These five buttons can be programmed for simple transmission or a combination of many commands, which is also known as macros or scenes. An example would be a welcome home macro to unarm security system, open the garage door for your car to enter, open window blinds and turn ON air-conditioning system to welcome you home. For convenience, 503 is a hole for keyring for users to attached their car keys and house keys. 504 is for user to enable or disable operations of 502 buttons. This is also known as keylock to prevent accidental pressing of any buttons when users put their miniRCU 500 into their pockets or in their cars.

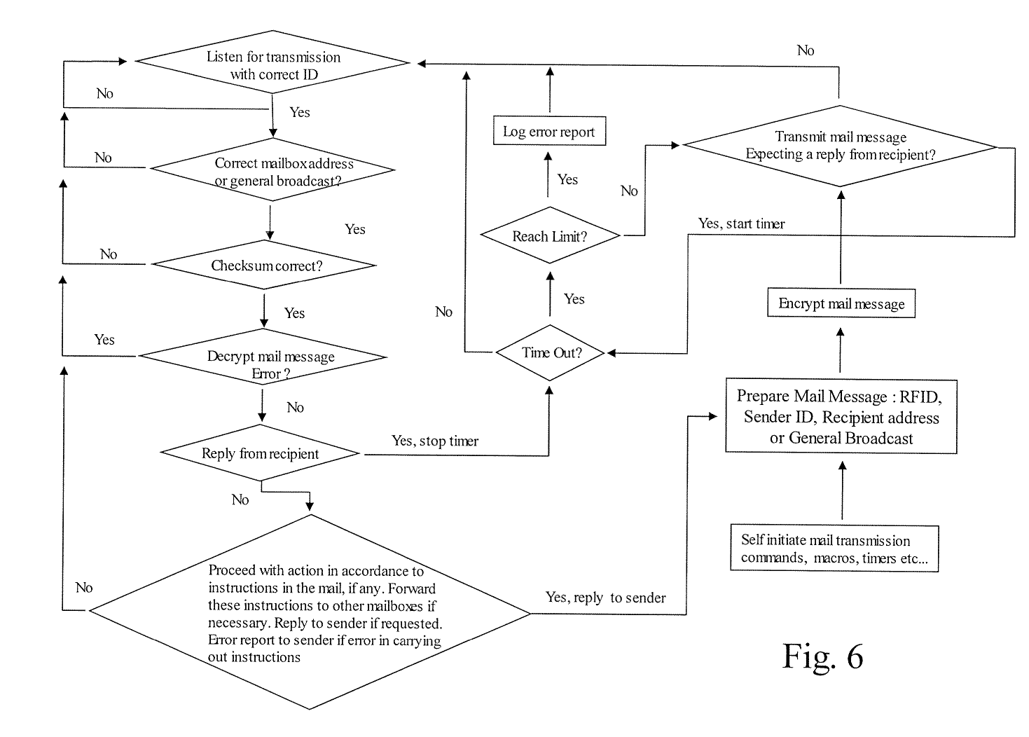

FIG. 6 is a flow chart of how mailboxes talk to each other. The method of communication for the system according to one aspect of the disclosure is based on the concept of mailboxes. Every unit is a mailbox except 400 which is a handheld infrared transmitter with no receiving capability. When mailboxes receive a transmission with the correct identification and a correct checksum it will check if it is a general broadcast or a peer to peer transmission. All receiving mailboxes then decrypt the mail to access the contents. If it is a general broadcast, all receiving mailboxes will proceed to execute the instructions in accordance to the contents of the mail, if such instructions are related to each respective mailbox. If these instructions are not related to the receiving mailbox, these instructions will be ignored.

If it is a peer to peer transmission, all receiving mailboxes then decrypt the mail to access the contents, and mailboxes with the corresponding recipient ID will proceed to execute the instructions in accordance to the contents of the mail. An example of these instructions set are: sender ID, recipient ID, error code, update, properties, send, change, accept, reject, re-send, receive, keep, time, delete, forward, re-forward, zone, ON, OFF and the likes for intercommunication amongst mailboxes that populate said system.

Outgoing mail will be encrypted before sending. If a reply is expected, a reply timer will be started. If the timer expired without receiving a reply, the mailbox will know that its transmission is corrupted or intended recipient has malfunction. Several re-send will be attempted until a limit is reached and these failures will be logged for trouble shooting purposes.

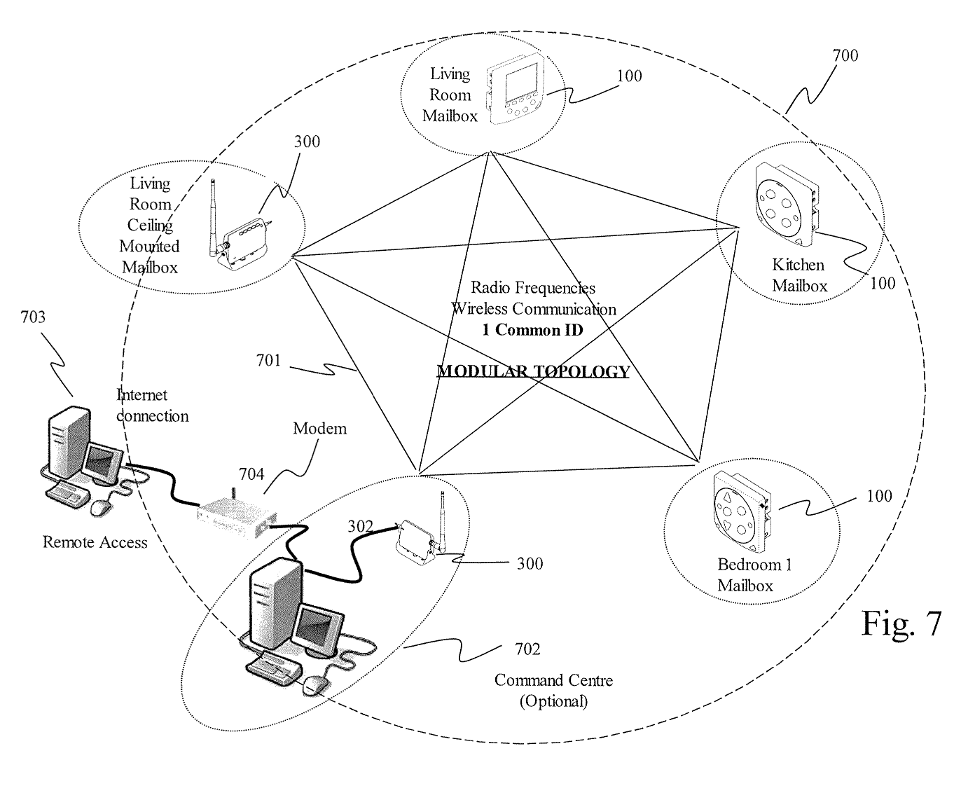

FIG. 7 shows one embodiment of 700, a typical modular topology of the system according to one aspect of the disclosure installed in a house using a combination of different types of microprocessor control switch panels 100 and several MPUs 300 as mailboxes. Intercommunication 701 uses the same identification and frequency channel for a secure and encrypted group communication. 702 is a combination of computer installed with graphical user interface software and MPU 300 connected to the computer via its communication port 302. A possible communication port is a USB port. 702 is used as a setup computer during setup and initialization of the whole system. After completion of setup and initialization, user can optionally retain 702 as a central command centre. In combination with a modem 704, a telecommunication line and internet connection, 702 becomes a remote access gateway to send and receive Short Message Service (also known as texting), voice communication and status notification for security system. The intended recipients could be the police, hospital or even manager of a building.

FIG. 8 elaborates further on FIG. 7 especially on lighting, connected electrical appliances, remotely controllable subsystem devices and handheld control devices. 801 shows an array of lighting and appliances connected to microprocessor control switch panel 100. 802 shows appliances that are not necessarily connected to the system according to one aspect of the disclosure physically but still can be controlled via MPU units 300. 802 are appliances that come with handheld infrared remotes like TV, satellite cable box or even media devices like DVD player and audio system. User can create a virtual remote using 702 setup computer via an MPU 300-A connected to the USB port 302. This digitized infrared information is transmitted in RF to target location and reconverted by receiving MPU to its original infrared signal to control the intended appliances as if it were the transmission from the original manufacturer's infrared remotes (FIG. 3E).

An example that a virtual remote created by 702 setup computer can control 802 appliances by transmitting from MPU 300-A to MPU 300-B. Upon receipt of the radio frequency communication from MPU 300-A, MPU 300-B will convert to its corresponding original infrared signals and transmit these signals to control 802 appliances.

803 are remotely controllable subsystem which comprises of third party devices like sensors, switches, sirens or any type of devices that can be driven by voltage level of high or low representing logic ‘1’ or logic ‘0’, or providing an open circuit or close circuit status in returning a voltage level of high or low representing logic ‘1’ or logic ‘0’. On every MPU 300 there are five input/output (I/O) ports, represented as 308 in FIG. 3. Each I/O port of 308 consist of a pairs of wires, outgoing and incoming, to complete the circuit when connected to third party devices. Input signals to 803 can come from any mailboxes, and similarly output signals of 803 can also go to any mailboxes. An example of input signals to 803 could be a handheld infrared transmitter 400 to arm the sensor of the security system. Or computer 702, that sends a signal to drive a pair of audio speakers 803. An example of output signals from 803 is when the security system is triggered, the audio alarm can be sounded at selective locations on any microprocessor control switch panels 100. Switches on microprocessor control switch panels 100 can be instructed to turn ON or turn OFF lights at selected locations or via command through MPU 300 USB port 302 to send an e-mail or text messaging from computer 702.

FIG. 9 shows one embodiment of communicating control by proxy. A mailbox is allowed to request another mailbox to control or communicate with other mailboxes on its behalf. The autonomy to make decision given to the proxy mailbox 900 to act on behalf is based on certain guidelines like rules, filters and/or occurrence of a certain conditions.

An example of a PC that has updated its real time clock on the Internet, and instead of broadcasting this clock information to every mailboxes, the PC transmit it to the proxy mailbox. The proxy mailbox will then confirm the clock information from the PC to its own clock according to a set of guidelines prior to deciding whether to re-synchronize all the clocks of other mailboxes

Another example, a handheld infrared transmitter 400 utilizes a microprocessor control switch panel 100-A or MPU 300-A as a proxy mailbox to control switches on other microprocessor control switch panel 100 or sensors on MPU 300 at remote locations.

A multi way switching control is another example of communicating control by proxy where user can easily clone any switch in the building and place it at the location of his choice.

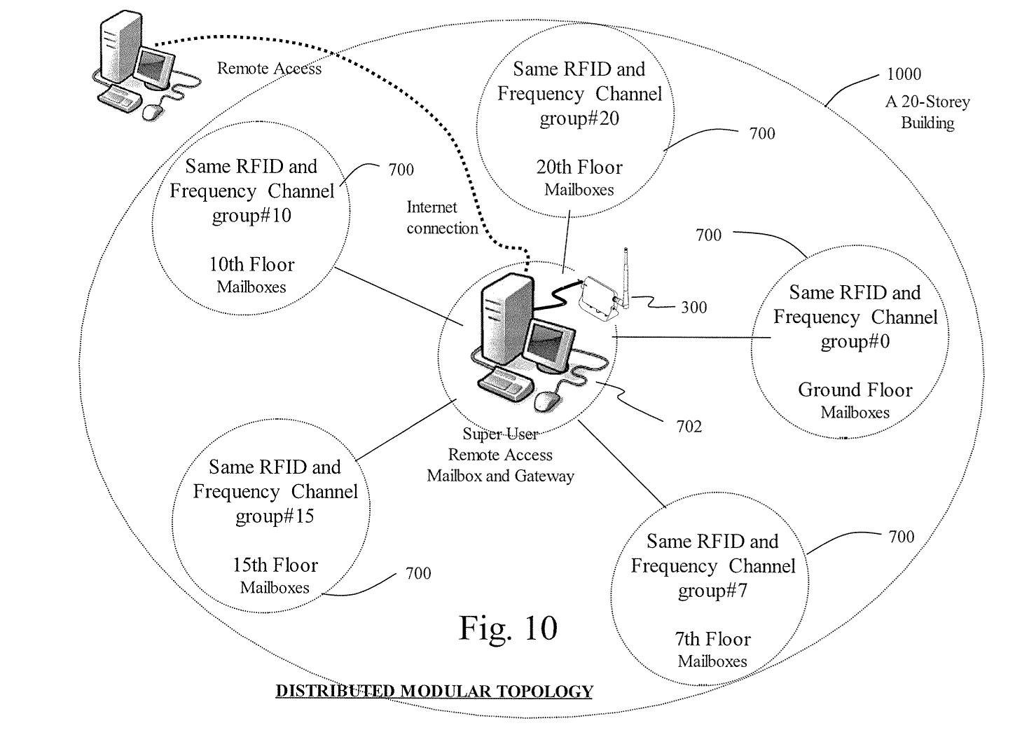

FIG. 10 shows one embodiment that further elaborate on the modular topology of FIG. 7 of the system according to one aspect of the disclosure. In 1000, each 700 module works independently and share connectivity and information on-demand basis. FIG. 10 is a 20-storey building while FIG. 7 is a small home, comparatively it is obvious that the scale of control has become bigger and wider.

The foregoing description of the preferred embodiments of the invention has been presented for the purpose of disclosure. It is not intended to be exhaustive or to limit the invention and description. It is not intended to be exhaustive or to limit the invention to the precise form disclosed. In light of the above teaching, many modifications and variations are possible and readily apparent to those skilled in the art. It is intended that the scope of the invention be limited not with this description, but rather by the claims appended hereto.

What is claim is:

1. An expandable wireless control system for managing and controlling remotely controllable subsystem in building comprising:
a) providing wireless means of intercommunicating mailboxes
b) means for using common identification and verification method for said mailboxes for secure wireless intercommunication, the advantage wherein a centralized control panel is not required.
c) ad hoc means, of adding at least one of said mailboxes, to further expand said system,
d) providing means for said mailboxes to interpose with said remotely controllable subsystem thereby having the means to control said subsystem to become a part of said system

2. The system according to claim 1, wherein said mailboxes comprising at least one of the devices selected from the group comprises of:
a) microprocessor control switch panel
b) handheld remote control devices
c) user input interface for data and command input means a keypad that communicates information received from said system and also accepts inputs by said user for instructing the systems to perform its control operations,
d) multi purpose transceiver unit (MPU) to interpose with remotely controllable subsystem thereby having the means to control said subsystem to become a part of said system
e) in combination, a graphical user interface (GUI) software means for providing a processor based computing device (PC) with communication port means for MPU with communication interface (MPUCOM) to interpose with said PC and said system whereby turning said PC into a setup computer and centralized command center managed by said graphical user interface software,
i. said setup computer further including a modem through which said system interpose as a gateway to external resources and information retrieval database, whereby providing updates and improvement to said system of mailboxes and also providing remote access to users to access and control said system of mailboxes remote from where said system is located.

3. The system according to claim 1, wherein every said mailbox of said system has a copy of said common identification and verification information wherein comprising:
a) means for a common multi-digit alphanumeric radio frequency identification (hereinafter refer to as RFID) for encryption, decryption and frequency channel for secure radio frequency intercommunication amongst said mailboxes
b) means for a common infrared remote identification number (hereinafter refer to as RID) for encryption, decryption and frequency channel for secure infrared intercommunication amongst said mailboxes

4. The system according to claim 1, wherein said remotely controllable subsystem comprises of at least one of electrical power management system, lighting system, security system, access control system, heating ventilation and cooling system (HVAC) and electrical appliances.

5. The system according to claim 1, wherein said mailboxes can be selected as a master clock source whereby keeping all clock of said system synchronize comprises
a) first means select a mailbox as master clock source
b) second means wherein said master clock source mailbox periodically access internet sites to update its master clock to ensure clock accuracy
c) second means wherein said master clock source mailbox periodically broadcast clock information for any mailboxes of said system to use said clock information to synchronize individual mailbox clock
d) third means said master clock source mailbox further including a backup battery to maintain clock survival when electrical power is not available and broadcast said clock information to all mailboxes of said system shortly after electrical power is restored

6. The system according to claim 1, wherein said mailboxes of said system can be configured to repeater mode to extend area of coverage of said system

7. The system according to claim 1, wherein said mailboxes can communicate control by proxy (FIG. 9)
a) Said communicating control by proxy allow a mailbox to request another mailbox to control other mailboxes on its behalf is known as proxy mailbox
b) Said proxy mailbox make decision and act on behalf of said requesting mailbox based on guidelines and occurrence of predetermined conditions imposed by said requesting mailboxes
c) Said guidelines and conditions are transmitted to said proxy mailbox from said requesting mailbox upon requesting said mailbox to become its proxy mailbox

8. The system according to claim 2, wherein said microprocessor control switch panel as point of convergence comprises,
a) means electrical power is directly available for onboard electronics to control and to selectively distribute to electrical appliances and lighting system connected to said microprocessor control switch panel of said system
b) providing visual and audio indicium of pertinent information of said remotely controllable subsystem, interposed by said MPU, to users on said plurality of microprocessor control switch panel
c) providing wireless input to said microprocessor control switch panel to perform its control operation onto said electrical appliances and said lighting system connected to said microprocessor control switch panel
d) providing wireless input to said microprocessor control switch panel to perform its control operation onto said remotely controllable subsystem, remote from said microprocessor control switch panel
e) providing direct input to said microprocessor control switch panel to perform its control operation onto said electrical appliances and said lighting system connected to said microprocessor control switch panel
f) providing direct input on said microprocessor control switch panel to perform its control operation onto said remotely controllable subsystem, remote from said microprocessor control switch panel

9. The system according to claim 2, wherein switches on different microprocessor control switch panel can be individually configure to become synchronize multi way switching means a method to configure any switch on said microprocessor control switch panel to remotely control another switch of another said microprocessor control switch panel at another location via radio frequency comprising
a) configuring synchronize multi way switch means to make a switch of said first microprocessor control switch panel to behave identically as a switch at said second microprocessor control switch panel
b) via radio frequency means action taken at either switch will be reflected similarly at both switches, means status of said action is transmitted via radio frequency where receiving switch will reflect similar status as transmitting switch
c) said multi way switching can synchronize more than 2 switches

10. The system according to claim 2, wherein different colour LED and buzzer on said microprocessor control switch panel to indicate power availability and status of security system means visual and audio indicium for electrical power availability and security status comprising
a) displaying only first colour of said LED means electrical power is available and security system is not arm
b) changing from first colour to second colour of said LED means security system is arm.
c) changing from second colour to first colour of said LED means security system is disarm.
d) Providing audio indicium in tandem with changing said LED colours means for arming of and disarming of said security system
e) displaying repeated interchanging of colour of said LED displaying first colour then second colour and vice versa means security system was breached

11. The system according to claim 2, wherein two backlighting colours means providing visual indication of said switch status and background events on said microprocessor control switch panel comprising
a) said background events means timers, calendars, macros and the likes
b) providing said backlighting position on said switch of first colour is located at opposite end of second colour whereby for easy colour differentiation
c) providing said switch with only first colour backlighting means said switch is in ON position and said electrical devices are connected and receiving electrical power and said background events are disable
d) providing said switch with only second colour backlighting means said switch is in OFF position and said background events are executing in the background.
e) providing said switch with first colour and second colour backlighting simultaneously means said switch is in ON position and said background events are executing in the background.
f) providing said switch wherein both backlighting is turned OFF means said switch is in OFF position and all background events disabled

12. The system according to claim 2, further including a battery power button on said microprocessor control switch panel whereby providing temporary power, via a battery located inside said microprocessor control switch panel, when electrical power is not available comprising
a) first means for pressing said battery power button to provide temporary power from said battery to electronics of said microprocessor control switch panel wherein said switches that are in ON position at the time of power failure will be back lighted, while switches in OFF position will not be back lighted.
b) second means while pressing said battery power button, user can select said switches on said microprocessor control switch panel to toggle from ON position to OFF position and vice versa
c) to select said switch means press and let go said switch to toggle the state of said switch
d) second means while pressing said battery power button, user can select said switches on said microprocessor control switch panel to change said power output level
e) to select said switch means pressing and holding said switch for a predetermined duration before letting go to increase said power output level to a new level for said switch
f) to select said switch means pressing and holding said switch for a predetermined duration before letting go to decrease said power output level to a new level for said switch

13. The system according to claim 2, wherein input interfaces on said microprocessor control switch panel can be programmed on how said input interfaces respond to wireless input and direct user input on said microprocessor control switch panel whereby preventing unauthorized access of said microprocessor control switch panel for use in public places comprising
a) means said input enable and disable of said switch has an exception such that input of configuration commands are always accepted and acted upon irrelevant of input port setting whereby said exception is necessary for reconfiguration of said switch else said switch will be stuck in a perpetual state when all input ports are disabled.

14. The system according to claim 2, wherein said microprocessor control switch panel collects daily electrical usage data on every switches on said microprocessor control switch panel for statistical analysis.

15. The system according to claim 2, wherein said setup computer to capture infrared frequency signal from any infrared transmitter via a photo diode inside said MPUCOM for controlling remotely controllable subsystem comprises
a) first means to assigned said digitized infrared signals to memory inside said setup computer for storing and retrieving said infrared signals
b) second means to control remotely controllable subsystem wherein said MPUCOM translate said digitized infrared signals, after retrieving from said memory, and transmit said translated signals in radio frequency to said MPUs interposing with said remotely controllable subsystem
c) first means to assigned said digitized infrared signals to buttons from said setup computer to said handheld remote control wherein said MPUCOM interpose with said handheld remote control by said intercommunication method between bi-directional mailboxes
d) second means to control remotely controllable subsystem wherein said handheld remote translate said digitized infrared signals and transmit said translated signals in radio frequency to said MPUs interposing with said remotely controllable subsystem
e) third means wherein said MPU convert said radio frequency signals back to infrared signals to control said remotely controllable subsystem interpose remote to said

16. The system according to claim 2, wherein said handheld remote control generating and transmitting coded infrared frequency instructions to control lighting, appliances and said remotely controllable subsystem comprises:
a) means to control electrical power to said lighting and appliances connected to said microprocessor control switch panel by continuously transmitting coded infrared frequency instructions to said microprocessor control switch panel wherein said electrical power is continuously increase until said electrical power to said lighting and appliances is at maximum or maintain at a predetermined power level upon cessation of further coded infrared frequency instruction.
b) means to control electrical power to said lighting and appliances by continuously transmitting coded infrared frequency instructions to said microprocessor control switch panel wherein said electrical power is continuously decrease until said electrical power to said lighting and appliances is completely turned OFF or maintain at a predetermined power level upon cessation of further coded infrared frequency instruction.
c) means to control electrical power to said lighting and appliances when said microprocessor control switch panel receive coded infrared instruction to turn ON by fully connecting electrical power to said lighting
d) means to control electrical power to said lighting and appliances when said microprocessor control switch panel receive coded infrared instruction to turn OFF by fully disconnecting electrical power to said lighting
e) means said microprocessor control switch panel to transmit by wireless means instructions to control remotely controllable subsystem interpose by said MPU comprises
i. first means wherein said instructions are transmitted via radio frequency by said microprocessor control switch panel to said MPU
ii. second means wherein said MPU execute said instructions to control said remotely controllable subsystem interpose via direct wiring connected to said MPU
iii. second means wherein said MPU convert said instructions to infrared to control said remotely controllable subsystem interpose remote to said MPU wherein said remotely controllable subsystem have infrared handheld transmitter and an infrared receivers on said subsystem like television, DVD players, hi-fi audio system and the likes

17. The system according to claim 2, wherein said handheld remote control generating and transmitting coded radio frequency instructions to control lighting, appliances and said remotely controllable subsystem comprises:
a) means to control electrical power to said lighting and appliances connected to said microprocessor control switch panel by continuously transmitting coded radio frequency instructions to said microprocessor control switch panel wherein said electrical power is continuously increase until said electrical power to said lighting and appliances is at maximum or maintain at a predetermined power level upon cessation of further coded radio frequency instruction.
b) means to control electrical power to said lighting and appliances by continuously transmitting coded radio frequency instructions to said microprocessor control switch panel wherein said electrical power is continuously decrease until said electrical power to said lighting is completely turned OFF or maintain at a predetermined power level upon cessation of further coded radio frequency instruction.
c) means to control electrical power to said lighting and appliances when said microprocessor control switch panel receive coded radio instruction to turn ON by fully connecting electrical power to said lighting
d) means to control electrical power to said lighting and appliances when said microprocessor control switch panel receive coded radio instruction to turn OFF by fully disconnecting electrical power to said lighting
e) means to transmit coded radio instructions to change control settings of remotely controllable subsystem via said microprocessor control switch panel to said MPU interposing with said remotely controllable subsystem (803) comprises
i. first means wherein said instructions are transmitted via radio frequency by said microprocessor control switch panel to said MPU
ii. second means wherein said MPU execute said instructions to control said remotely controllable subsystem interpose via direct wiring connected to said MPU
iii. second means wherein said MPU convert said instructions to infrared to control said remotely controllable subsystem interpose remote to said MPU wherein said remotely controllable subsystem have infrared handheld transmitter and an infrared receivers on said subsystem like television, DVD players, hi-fi audio system and the likes

18. The system according to claim 2, wherein said MPU interpose by direct wiring connection via its input/output (I/O) port thereby having control of said remotely controllable subsystem comprises
a) providing said MPU comprises of I/O port (308) wherein output voltage level representing binary logic of ‘0’ and logic ‘1’ where said remotely controllable subsystem can connect to in a serial manner, with a return path to an input pin to complete the loop, wherein a change in logic level at said input pin indicates a break in said loop
b) providing said I/O port comprises of output that controls switching of relay to connect and disconnect remotely controllable subsystem
c) providing said I/O port comprises of programmable I/O pins that remotely controllable subsystem can connect to
d) providing said I/O port comprises of programmable clock pin that remotely controllable subsystem can connect to
e) providing said I/O port comprises a common ground pin, to be shared among attached remotely controllable subsystem

19. The system according to claim 2, wherein said microprocessor control switch panel comprise of LCD screen for audio/video communication means

20. The system according to claim 3, means for using said common identification and verification method to setup and initialize said wireless system of intercommunicating mailboxes for secure wireless communication comprises:
a) said setup means mailboxes of said system are installed at locations with electrical wiring connected and turn electrical power turn ON.
b) a setup computer means a combination of a processor based computing device, like a laptop computer, loaded with said graphical user interface software with said MPUCOM connected to a communication port ready to interpose with said mailboxes of said system
c) said mailboxes, setting up for the first time, have factory default Radio Frequency Identification (RFID) setting which allows it to listen and respond, at a pre-agreed default channel, to a ‘Ping’ broadcast by a person from said setup computer
d) Said ‘Ping’ is a radio frequency transmission that requests all said mailboxes of said system with factory default RFID to identify itself by audio and visual indicators
e) said RFID is a radio frequency identification number use by all mailboxes for intercommunication to authenticate each other as member of the group that it belongs to.
f) Said person walks around, location by location, and physically press any switch, once, on each said mailbox that responded to said ‘Ping’, thus enabling each said mailbox to transmit its unique serial number by radio frequency to said setup computer. Said mailboxes that do not have switches, like MPU, and said mailboxes located in a position that is difficult to access can be urged to transmit its serial number to said setup computer by pointing said handheld infrared remote at said mailboxes. Said handheld infrared remote (400) then transmit to said mailboxes using a pre-agreed default channel, and upon receipt of this infrared transmission, said mailboxes transmits its serial number to said setup computer
g) Said mailboxes that were not selected to transmit its serial number in respond to said ‘Ping’ will automatically turn OFF its audio and visual indicators and goes into standby state after a predetermined time. Said mailboxes that have not yet updated its factory default RFID can still respond to future ‘Ping’
h) Said mailboxes that has updated its factory default RFID to newly received RFID is no longer allow to respond to future ‘Ping’
i) said mailboxes that have responded to said ‘Ping’ and has transmitted its serial number will automatically turn off its audio and visual indicators and go into a receiving state for a predetermined duration.
j) said setup computer will encrypt and transmit a new RFID, channel number and a new RID in accordance to said mailbox with said corresponding serial number to update its factory default RFID, channel number and RID whereby providing a secure grouping of intercommunicating wireless mailboxes.

21. The system according to claim 20, said setup computer is then turn OFF and excluded from said group after completing said setup and initialization

22. The system according to claim 20, wherein any of said mailboxes can be excluded from said group by resetting its copy of said RFID and said RID number.

23. An expandable wireless control system for managing and controlling remotely controllable subsystem in building comprising:
a) providing wireless means of intercommunicating mailboxes
b) means for using common identification and verification method for said mailboxes for secure wireless intercommunication,
c) means for providing a centralized control panel interposing with all said mailboxes to provide system status and control of said system by audio and visual communication interface means, wherein after setup and initialization, said centralized control panel is left intact and became a part of said system
d) ad hoc means, of adding at least one of said mailboxes, to further expand said system,
e) providing means for said mailboxes to interpose with said remotely controllable subsystem thereby having the means to control said subsystem to become a part of said system

24. The system according to claim 23, wherein said centralized control panel means in combination, a graphical user interface (GUI) software means for providing a processor based computing device (PC) with communication port means for MPU with communication interface (MPUCOM) to interpose with said PC and said system whereby turning said PC into a setup computer and command center managed by said graphical user interface software.

25. The system according to claim 24, wherein said setup computer further including a modem through which said system interpose as a gateway to external resources and information retrieval database, whereby providing updates and improvement to said system of mailboxes and also providing remote access to users to access and control said system of mailboxes remote from where said system is located.
